(19) United States
(12) Patent Application Publication
(10) Pub. No.: US 2010/0008601 A1
(43) Pub. Date: Jan. 14, 2010

(54) Snow mat-bag

(76) Inventor: Yves Coffi PRUDENCIO, Cotonou (BJ)

Correspondence Address: Yves Coffi PRUDENCIO, P.O. Box 4309, Rockville, MD, 20849, US

(21) Appl. No.: 12/170,408

(22) Filed: Jul. 9, 2008

(51) Int. Cl. B65D 30/00

(52) U.S. Cl. 383/4

(57) ABSTRACT

The snow mat-bag is a rectangular piece of flat plastic tarpaulin or canvas of different sizes as needed, equipped with straps, ropes, handles and zippers on its edges to collect, bag and transport snow away from driveways and sidewalks during the winter by closing the zippers and tying the straps and ropes. It can also be used to collect, bag and move away other objects such as dead leaves from yards during the fall, clothes for laundry, grains and fruits for storage on farms.

### BACKGROUND OF THE INVENTION

1. Field of the Invention

The present invention relates to an apparatus for collecting, bagging and transporting snow and other movable objects or articles outdoors and indoors.

2. General Background and State of the Art

This invention was primarily designed to facilitate the removal of snow from driveways and walkways during the winter time. It became subsequently obvious that it could also be used to facilitate the removal of dead leaves from yards during the fall and also serve for the transportation of various movable objects outdoors and indoors.

With respect to snow removal from driveways and walkways outdoors, the snow removal tools currently used such as shovels, various types of salt or snow/ice melters, snow blowers, etc. are either labor intensive, time consuming, energy consuming, financially expensive, risky and not necessarily environment friendly. The proposed invention attempts to address all these concerns with a simple less labor intensive, less time consuming, less expensive and more environment friendly tool. With the proposed invention, snow accumulation of up to 10 inches or more on a fifty square feet surface of driveways or sidewalks can be removed within two to three minutes, about one fifth of the time needed to do so when using conventional methods and tools.

Attempts have been made in the past to tackle these concerns with electric heated mats (U.S. Pat. Nos. 6,051,811, 5,380,988; 5,291,000; . . . ), snow removal and transportation devices (U.S. Pat. No. 4,185,403), snow and ice melting blanket devices (U.S. Pat. No. 6,051,812); all of which are more complex, pose more health and environment risks, and are more expensive than the proposed invention.

With respect to collection and disposal of leaves and debris from yards, excessive energy is conventionally used by using blowers over large distances or by filling and transporting several leave bags out of the yard, in all cases by spending enormous amounts of energy. My invention provides a simple alternative solution at the lowest possible energy cost.

With respect to other domestic or outdoor usages of this bag, such as taking out a big load of clothes to laundry, collecting and moving harvested fruits or grains to trucks and/or storage, these tasks are usually accomplished by using for a big load of objects several small containers with several trips to get done. My invention provides a simpler, cheaper and more efficient solution to get the job done quickly with fewer trips.

### SUMMARY OF INVENTION

My invention is based on the very simple concept of laying down in the driveway or on the sidewalk a rectangular and flat piece of flexible waterproof material/fabric such as plastic tarpaulin or canvas, equipped with zippers, straps and ropes on its edges, use it first as a mat to collect the snow during snow accumulation, and then transform the mat into a bag after the snow accumulation by closing the zippers and tying up the straps and ropes. The bagged snow can then be easily moved out of the driveway or walkway by pulling or lifting the loaded mat-bag using handles located on its four sides. The same principles are used to collect and move other items such as dead leaves during the fall, clothes for laundry, grains and fruits to storage on farm, etc. My invention as further described and demonstrated in the attached drawings and text has two basic designs: a light duty Type A design made with a relatively light plastic material and a heavy duty Type B design made out of a heavier duty material such as thick military-style canvas.

### BRIEF DESCRIPTION OF THE DRAWINGS

FIG. 1 is an elevational view of the face of the mat-bag in accordance with its light duty type A design at the mat stage.

FIG. 2 is an elevational view of the back of the mat-bag in accordance with the type A design of this invention at the mat stage.

FIG. 3 is an elevational view of the mat-bag, in accordance with its Type A design at the bag stage

FIG. 4 shows a perspective view of the first operation step of the type A mat-bag, with the mat laid down on the floor, all four side flaps folded underneath and conic bricks placed on top of the mat-bag in all four corners, carrying the free ends of the ropes.

FIG. 5 shows the second operation step of the type A mat-bag: the pulling-up of the ropes to wrap-up the snow and form the bag

FIG. 6 is a graphic view of the internal and external components of the mat-bag in accordance with its heavy duty type B design at the mat stage

FIG. 7 is a perspective view of the face of the mat-back in accordance with its type B design at the mat stage

FIG. 8 is a perspective view of the back of the mat-back in accordance with its type B design at the mat stage

FIG. 9 is an elevational view of the mat-bag in accordance with its type B design at the bag stage.

FIG. 10 shows an operation step: the conversion from mat to bag, with the type B design

### DESCRIPTION OF THE PREFERRED EMBODIMENTS

1. The Light Duty Type A Design: Construction and Operation

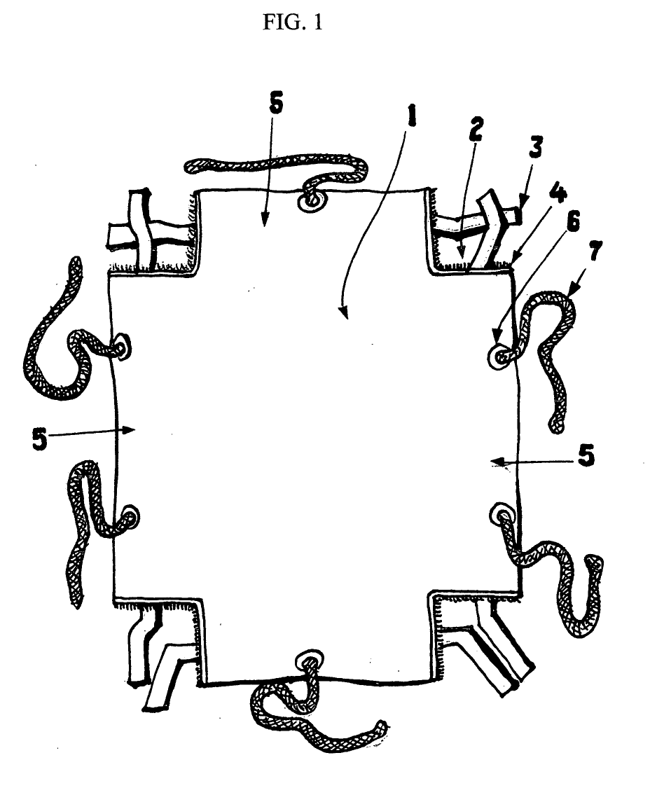

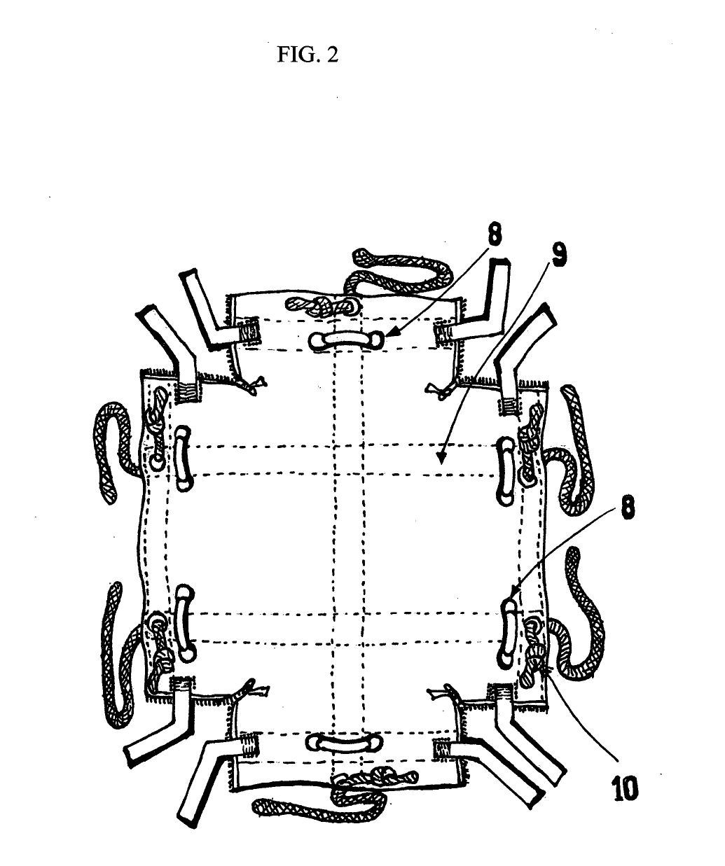

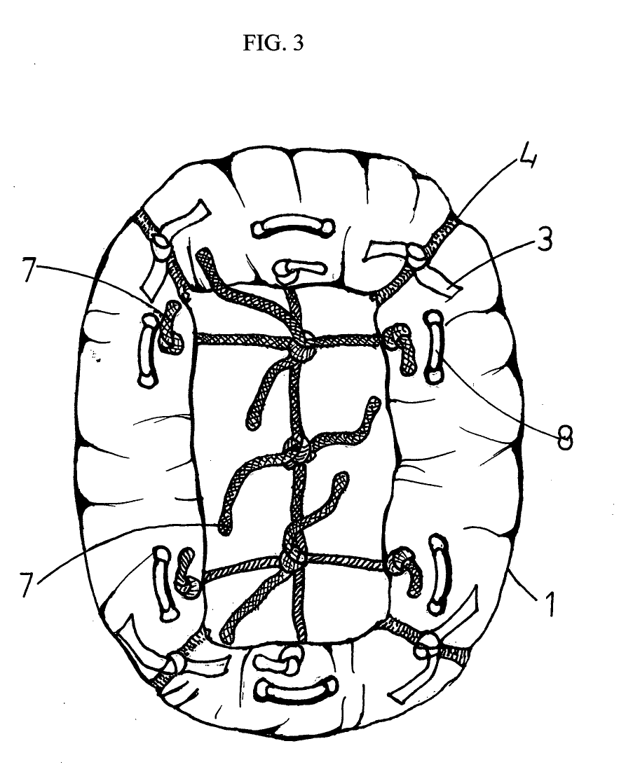

With reference to FIG. 1 and FIG. 2. The central piece of the light duty type A mat-bag is a rectangular piece of thick plastic tarpaulin material 1 (at least 5 mils thickness) of various sizes (standard 5.2′×7.2′), commonly sold in home stores. Squared pieces of about one square foot (for the standard size) or more are removed from each corner 2 to allow for the installation of heavy duty straps 3 and zippers 4 which when tied and/or closed transform the flat plastic piece or mat into a boat-like bag (FIG. 3) to contain the snow. The plastic mat has on its edges (or side flaps) 5 on each side one to two ringed holes 6 (of about one inch diameter each) through which ropes 7 can be inserted to bring the opposite edges or flaps 5 of the mat together to form the bag.

The ropes 7 are about four to five feet long with a knot 10 at one end (FIG. 2); the end without the knot is inserted into the ringed hole trough the back of the mat and the knot which is bigger than the hole acts as a stopper. The ropes used are ordinary strong ropes made of nylon with about one half inch diameter. As in the case of ordinary tarpaulin and canvas sold in stores, a metallic or plastic ring covers and protects the edges of the holes 6 through which the ropes are inserted. When the ropes 7 on opposite sides are tied up together two by two, they transform the mat into a bag for carrying objects (FIG. 3).

Other stronger straps 8 (FIG. 2), one or two on each side of the bag provide the handles 8 to be gripped to take the bag away either by carrying it (two people or more, each holding one or two handles) or by dragging it away on the floor from one end by pulling on the handles 8 on one side (one person). Areas that carry the handles and ringed holes are reinforced by doubling the plastic material 9, so as to provide greater resistance against tearing forces when carrying or pulling the bag.

The straps 3, two to four in each cut corner 2, are made of the same plastic tarpaulin fabric, they are sown at the top and/or near the middle of each cut corner about two inches away from the corner edges. In addition one heavy duty zipper 4 may be installed per cut corner, with each one of the two parts of the zipper covering each one of the two edges of the cut corner.

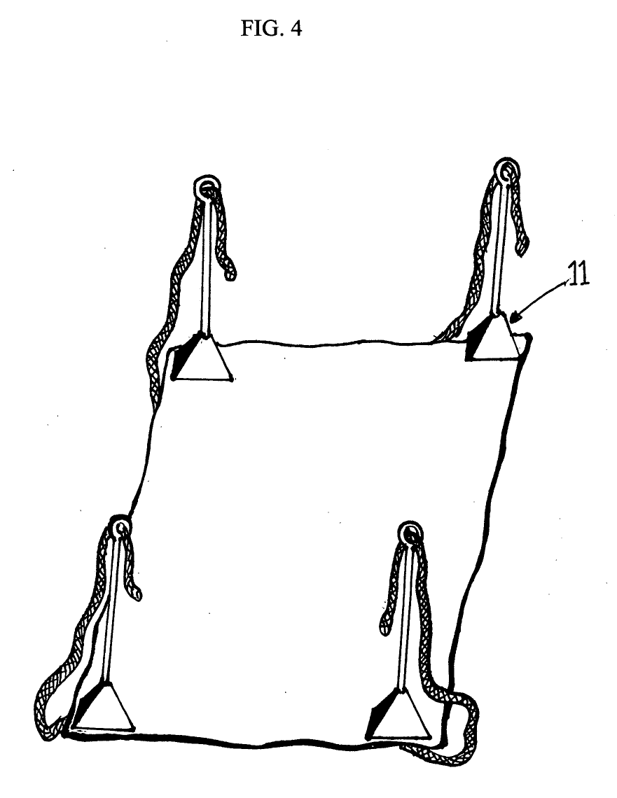

Regarding operation, the four to five feet long ropes with knots 10 on one end are inserted into the ringed holes through the back of the mat-bag. The knots are big enough to not go through the holes and consequently act as the rope stoppers. In the next step, the four side flaps 5 are turned down, folded down against the back of the mat-bag before laying the latter in the driveway as shown in FIG. 4.

The ropes can be left below the mat-bag making sure that they are easily accessible below the edges after the snow accumulation. One easier option is to put conic bricks 11 on the four corners of the mat-bag as shown in FIG. 4 to stabilize it on the floor especially in windy conditions and place the free ends of the ropes on a metallic (iron) ringed rod encrusted inside and on top of the bricks, so as to easily locate the ropes after the snow fall or storm and pull them to wrap up and bag the snow. Alternatively, the ropes can also be tied up together and left on the top iron rod ring of a single conic brick in the middle of the mat so as to be easily reached after the snow fall. The conic brick, measuring about 8 to 10 inches wide and high, may be made of concrete (cement) and molded with the encrusted iron rod, both forming one piece. The iron rod is 3 to 4 feet high above the conic brick, has a circular section of about one half inch in diameter and the same applies for its top ring.

The ropes can also be tied to sticks or to plants or trees near the driveway or walkway so as to be easily visible and accessible after a heavy snow fall.

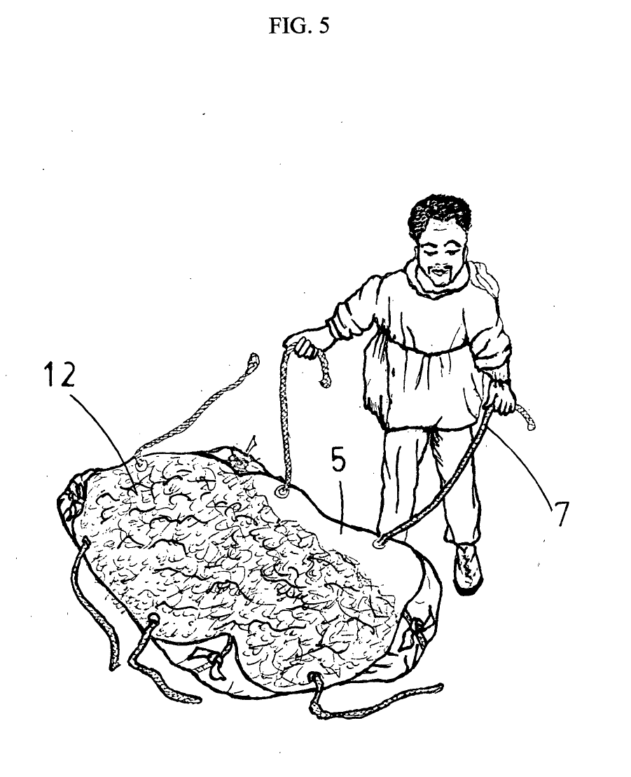

After the snow accumulation on the mat-bag, the operator pulls up the free ends of the ropes as shown in FIG. 5. When the ropes 7 are pulled upward, the side flaps 5 automatically unfold upward and wrap the snow content 12 on its sides. Once all ropes are pulled up and all four side flaps are unfolded, the operator ties the opposite ropes two by two so as to form the bag (FIG. 3) to contain and move the snow away.

Regarding operation for other usages of the mat-bag such as removing dead leaves from yards during the fall, the mat-bag is laid down at its mat stage on the floor with all four flaps folded down underneath as in the case of snow collection. The leaves are then pushed onto the mat by using either brooms, racks or blowers. Once a large quantity of leaves is piled on top of the mat the operator pulls up the ropes to unfold the side flaps, wrap and bag the leaves by tying up ropes and straps and by closing zippers. The same process will be used for collecting and bagging other items such as clothes, grains or fruits on the farm, etc.

2. The Heavy Duty Type B Design: Construction and Operation

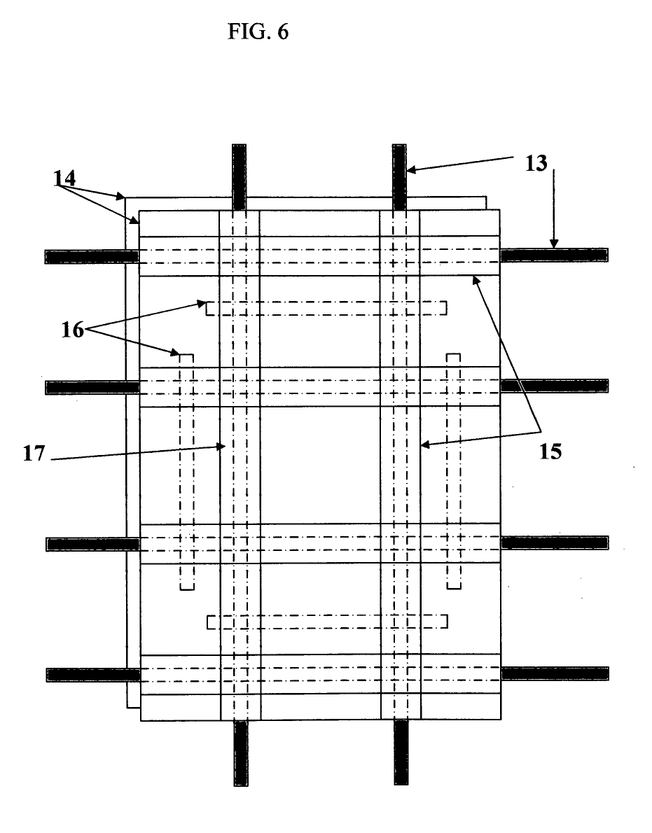

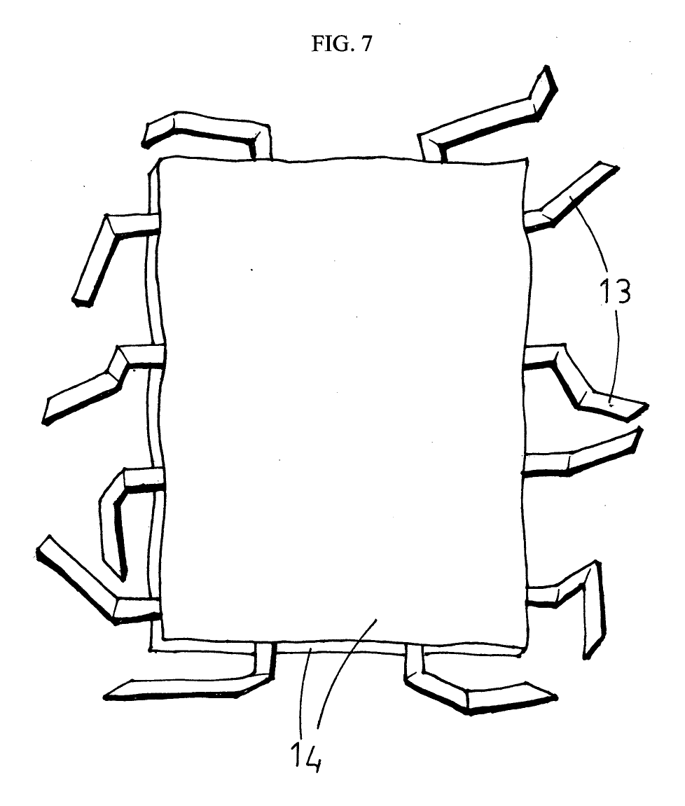

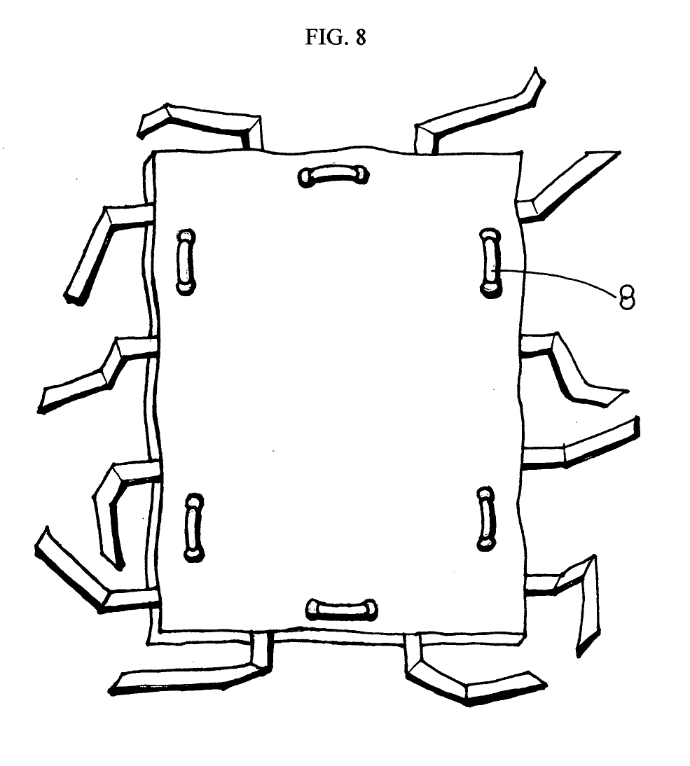

With reference to FIG. 6 through FIG. 10 the Type B mat-bag is designed to be a heavy duty mat-bag. It is made out of army-style canvas material, typically 82″ long and 55″ wide. The principle of a flat piece of material for items collection and of tying up edges to transform the flat piece (mat stage) into a bag for transporting the collected items remains the same. In this case, there are no ropes, adjustable or fixed belts 13, made out of the same canvas fabric and placed across the length and the width of the canvas are used to form and tie the bag. The canvas is doubled all across its surface 14. Reinforcements 15 along the belts and reinforcements 16 beneath the handles are sown to provide greater resistance to all tearing forces.

With reference to FIG. 6 showing the interior of the type B mat-bag, the canvas may be sown in such a way as to provide furrows 17 within which the belts 13 could move freely and be adjusted as needed. Alternatively and preferably, the mid sections of the belts can instead be fixed by sowing them onto the canvas layers leaving only the external ends (3-4 feet) free. Typically the mat-bag is constructed with equidistant belts across the length and the width of the mat-bag, with the two exterior belts along the length as close as possible (two to ten inches) to the edges of the mat so as to provide good control of the snow content in the four corners of the mat-bag. Doubled pieces of the canvas, about two inches wide and one foot long are sown on the back of the mat-bag, about one foot away from the edges to provide the handles to carry the bag. Typically six handles are provided, one along each width and two along each length of the rectangular mat-bag.

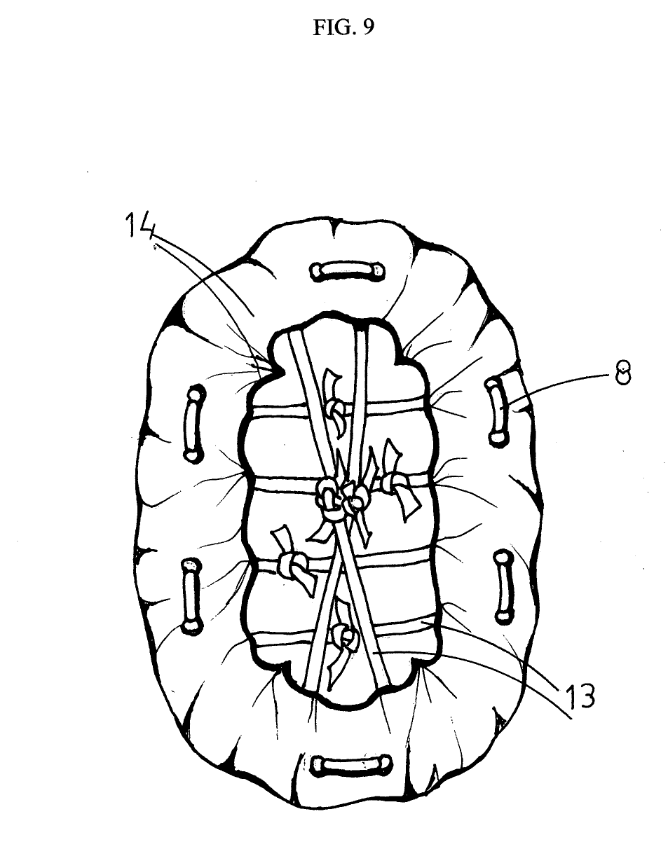

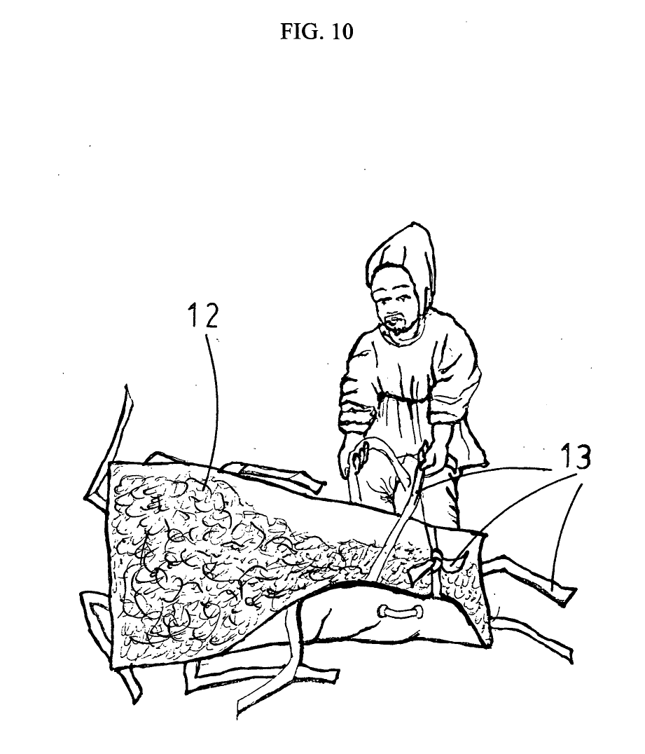

Regarding operation, the mat-bag is laid down on the driveway or walkway before the snow fall, with about one foot of all four sides folded underneath to act as flaps and the free ends of the belts are left hanging or tied on top of conic bricks placed above the mat-bag in all four corners and/or in the middle of the mat-bag as judged appropriate by the operator. After the snow accumulation, the operator pulls up the free ends of the top corner belts 13 and tie them up diagonally (tie top belts located at diagonally opposite corners) as shown in FIG. 9 before tying up two by two the remaining laterally located opposite belts as shown in FIG. 9 and FIG. 10 to contain the snow. The result is a bag of snow that can be moved away by lifting the bag or by dragging it on the floor using some or all of the six handles.

### References Cited

U.S. Patents Documents

| | | |
|---|---|---|
| 6051811 | April, 2000 | Hardison |
| 5380988 | January, 1995 | Dyer |
| 5291000 | March, 1994 | Hornberger |
| 4185403 | January, 1980 | Hardgrove |
| 6051812 | April, 2000 | Walker |

1. The overall design of the snow mat-bag as shown and described.

2. A central flat piece of canvas, of plastic or of any foldable material of rectangular shape, equipped with straps, zippers, handles and ropes at its corners and sides for the purpose of collecting, bagging and moving snow and other objects outdoors and indoors;

3. The mat-bag as set forth in claims 2 wherein: the mat is convertible into a bag, with a mat stage to easily collect snow or other items and a bag stage to transport/move the snow or other items.

4. The mat-bag as set forth in claims 2 wherein: it is made with different types of strong and flexible water resistant or waterproof materials, in particular plastic tarpaulin and canvas, doubled across the entire or most of the body of the mat-bag in order to provide strong resistance to tearing forces.

5. The mat-bag as set forth in claim 2 wherein it has two designs, a light duty type A design and a heavy duty type B design.

6. The mat-bag as set forth in claim 2 wherein Type A includes four squared cuts in all four corners of the rectangular flat mat to carry zippers and/or straps or fasteners; with the four corner cuts also creating four rectangular flaps around the mat.

7. The mat-bag as set forth in claims 2 wherein: in type A all four corners of the rectangular mat are equipped with zippers and/or straps and all four side flaps are equipped with ropes passing through ringed holes (or alternatively with adjustable straps); all zippers, straps and ropes being used to convert the mat into a bag.

8. The mat-bag as set forth in claim 2 wherein the heavy duty Type B design has no corner cuts with zippers, and is instead made with two layers of heavy duty material such as canvas, with adjustable belts across the length and width of the mat, inserted in-between the two layers with ends appearing on all four sides and corners of the mat; with the conversion from mat to bag being made by tying opposite belts.

9. The mat-bag as set forth in claim 2 wherein it is a multi-purpose collection and bagging device with a central mat convertible into a bag primarily designed for rapid mechanical collection/gathering and removal of snow from driveways and walkways, a mat that is secondarily useful for collecting and bagging other items outdoors and indoors, such as dead leaves, clothes, grains, etc.

10. The mat-bag as set forth in claim 2 wherein conic bricks, made with concrete and an encrusted metallic rod with a ring or hook on top, are used to stabilize the mat-bag during operation, especially in windy conditions, and to carry and make easily accessible the free ends of the ropes and belts to be used after a snow fall to convert the mat into a bag.
